(19) United States
(12) Patent Application Publication
(10) Pub. No.: US 2010/0184417 A1
(43) Pub. Date: Jul. 22, 2010

(54) METHOD AND SYSTEM FOR EFFECTING DATA COMMUNICATIONS WITH A WIRELESS DEVICE

(76) Inventors: Lynn Whittington, Granbury, TX (US); Jeffrey Wolf, Miami Beach, FL (US); Jonathan Pirie, Miami, FL (US)

Correspondence Address: LAW OFFICE OF DONALD D. MONDUL, PO Box 1203, 354 Moose Lane, Seeley Lake, MT, 59868-1203, US

(21) Appl. No.: 12/712,792

(22) Filed: Feb. 25, 2010

Related U.S. Application Data
(63) Continuation of application No. 11/894,202, filed on Aug. 20, 2007.

(51) Int. Cl. H04M 3/42; H04M 3/00

(52) U.S. Cl. 455/415; 455/419

(57) ABSTRACT

A method for effecting data communications with a wireless communication device includes: (a) configuring the wireless communication device for responding to at least one predetermined alert for initiating the data communications with at least one predetermined communicant; (b) transmitting the at least one predetermined alert to the wireless communication device; and (c) operating the wireless communication device in response to recognizing the at least one predetermined alert to initiate a data session for effecting the data communications with the at least one predetermined communicant.

This application is a continuation of and claims priority to, and incorporates by reference, U.S. patent application Ser. No. 11/894,202, filed Aug. 20, 2007.

### TECHNICAL FIELD

This invention pertains to data communications via wireless communications networks, and more specifically it relates to programming user functions and preferences in a wireless device or a piece of electronics containing wireless functionality.

### BACKGROUND OF THE INVENTION

Because of inherent limitations in the functionality and displays of user input controls on wireless devices or electronics containing wireless functionality, users often experience difficulty or confusion in attempting to adjust the operational features of such wireless devices. Due to a lack of knowledge about the capabilities of the features of the device and how to make adjustments to the device to effectively utilize such features, the capabilities of the device are often not fully utilized and thus, user satisfaction is not maximized.

Therefore, so that the user of a wireless device may be able to effectively utilize a wireless device and modify its features in an easy manner, a means of providing the user with the capability to simply select and activate the various features of the wireless device is desired.

### SUMMARY

A method for effecting data communications with a wireless communication device includes: (a) configuring the wireless communication device for responding to at least one predetermined alert for initiating the data communications with at least one predetermined communicant; (b) transmitting the at least one predetermined alert to the wireless communication device; and (c) operating the wireless communication device in response to recognizing the at least one predetermined alert to initiate a data session for effecting the data communications with the at least one predetermined communicant.

A system for effecting data communications with a wireless communication device by at least one communicant configured for wireless coupling with the wireless communication device includes: (a) an alert responsive unit coupled with the wireless communication device; the alert responsive unit being configured for receiving at least one predetermined alert; and (b) at least one alert transmitting device coupled with the at least one communicant; the at least one communicant employing the at least one alert transmitting device to effect transmitting at least one respective predetermined alert of the at least one predetermined alert to the wireless communication device. The wireless communication device responds to recognizing the at least one respective predetermined alert to initiate a data session for effecting the data communications with the at least one communicant.

In accordance with one embodiment of the present invention, a user of a wireless device is provided a menu of available options for activating, deactivating or adjusting the operational features of the wireless device. Using a voice communication device, such as a wire line telephone, a computer with VOIP capability, cellular telephone, or other wireless device having voice transmission capability, the user may access a server which provides an interactive voice response (IVR) menu. By using the IVR menu, the user may identify and select one or more features of the wireless device for adjustment or configuration. As is well known in the field of IVR technology, the user may select one of a plurality of designated telephone numbers to call to initiate the session, each called number associated with a separate one or group of wireless device features. For example, if the user desires to increase or decrease the earpiece listening volume, a voice communication may be initiated to a specific telephone number, URL, or IP address specifically for access to an IVR menu uniquely associated with controlling the listening volume of the wireless device.

Upon receipt of the user's communication via the specific telephone number, URL, IP address, or other identifying method, the IVR server may present information to the user concerning the selected feature or features that may potentially accomplish the user's objective. The menu for each device feature may include a description of the function and benefits of the feature, a tutorial on how to use the feature, and various options for activating, utilizing and/or adjusting the feature in the wireless device. With regard to the objective of changing the listening volume, the server may present the user a menu offering alternative options, such as: 1) raise the earpiece volume; 2) lower the earpiece volume; 3) activate a device feature which automatically changes the earpiece volume according to the level of the ambient sound; or 4) activate a noise-cancellation function of the device. The user may then select from the available options by speaking the appropriate voice command, which is recognized by the IVR function on the server. Based upon the user's command, the user may then be presented with successive menus for further options to execute the particular function selected by the user, or alternatively, for the user to receive further information about the selected function.

For example, if the wireless device user wishes to increase the volume to a level of 8 on a scale of 1 to 10, the IVR menu may prompt the user to speak the digit of the desired volume level. Upon recognition of this command, the IVR system server issues a short message service (SMS) message, GPRS message, Bluetooth transmission, WIFI transmission, JAVA, or other data signal, or other type of wireless instruction to the wireless device to modify the desired feature. Alternatively, the wireless device can be prompted by a particular caller ID signal sent by the server in an incoming voice call to initiate a data transfer session with a particular data server at a predetermined access address, such as an IP address or URL. In the data session, the wireless device may receive programming instructions for device features, from a remote data server.

Additionally, the wireless device may also be programmed to recognize a predetermined caller ID number as a unique programming command to be implemented by the wireless device for utilization of or adjustments to an internal feature. In this case, the device does not need to initiate a data session to receive programming commands from a remote data server, as the caller ID signal will trigger the device to access preexisting instructions on the wireless device memory corresponding to the received device feature programming command.

In another preferred embodiment, the system and method of the present invention may be used to remotely adjust, activate, or reprogram features of the wireless device by utilizing a web interface or portal, such as a computer connected by a network to the server. In this preferred embodiment, the user may use a personal computer or other access device to log on to a dedicated web portal which is preconfigured with various user-selectable commands which can be implemented in the wireless device. By using the user interface menu provided by the web server, the user may then access information to facilitate identifying and selecting one or more features of the wireless device. The menu for each device feature may include a description of the function and benefits of the feature, a tutorial on how to use the feature, and various options for activating, utilizing and/or adjusting the feature in the wireless device. As is well known in the field of web access technology, the user may select one of a plurality of designated URLs or IP addresses to access the server, each URL or IP address associated with a separate one or group of wireless device features. For example, if the user desires to increase or decrease the earpiece listening volume, the user may utilize a specific URL or IP address to access a user interface uniquely associated with controlling the listening volume of the wireless device.

Additional aspects and advantages will be apparent from the following detailed description of preferred embodiments, which proceeds with reference to the accompanying drawings.

### BRIEF DESCRIPTION OF THE DRAWINGS

FIG. 1 is a simplified diagram illustrating the system components of a preferred embodiment of the present invention.

FIG. 2 is a simplified high-level diagram illustrating certain embodiments of the methodology of the present invention.

FIG. 3 is an exemplar user interface application program menu in accordance with the present invention.

FIG. 4 is a flow diagram which further illustrates certain methodologies in accordance with the present invention.

### DETAILED DESCRIPTION OF THE PREFERRED EMBODIMENTS

Reference is now made to the figures in which like reference numerals refer to like elements.

In the following description, certain specific details of programming, software modules, user selections, network transactions, database queries, database structures, etc., are provided for a thorough understanding of the embodiments of the invention. However, those skilled in the art will recognize that the invention can be practiced without one or more of the specific details, or with other methods, components, materials, etc.

In some cases, well-known structures, materials, or operations are not shown or described in detail in order to avoid obscuring aspects of the invention. Furthermore, the described features, structures, or characteristics may be combined in any suitable manner in one or more embodiments.

### Remote Programming of Wireless Device by IVR System

In another preferred embodiment, the system and method of the present invention may be used to remotely adjust, activate, or reprogram features of the wireless device by utilizing an interactive voice response system (“IVR”). In this preferred embodiment, the user of the wireless device may access an IVR system by any voice transmission means, including the wireless device. The IVR system is preconfigured to recognize various voice commands associated with features of the wireless device, such as “increase the volume of my phone”. Upon recognition of a suitable command, the IVR will prompt a server to issue an short message service (SMS), GPRS or other type of wireless command to the device which can be interpreted to adjust, activate, or reprogram the designated device feature.

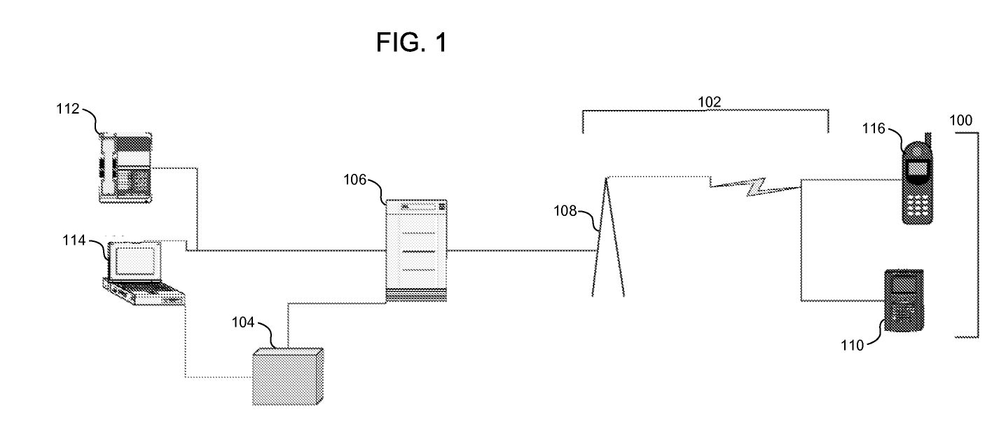

FIG. 1 is a simplified diagram illustrating the system components of a preferred embodiment of the present invention. Illustrated in FIG. 1 is a wireless device 100 capable of receiving instructions for programming the operational features of the device. The device 100 is connected via a wireless network 102 through a PSTN 106 to a server 104. The server 104 is capable of receiving input from a user via a voice communication from devices such as a land line telephone 112, a computer with VOIP capability 114, cellular telephone 116, or other wireless device having voice transmission capability, including the wireless device 100. The server 104 transmits instructions for programming the feature in accordance with the user's input to the wireless device via a wireless connection 102, such as a wireless carrier network. The wireless carrier network 102 is connected to the PSTN 106 for handling wireless call traffic, the details of which are well known. The wireless network 102 includes a series of base stations which include antennas and wireless transceivers, generally referred to as a cell tower 108. Transceivers are mounted atop the cell tower 108 for two-way wireless communications with various wireless devices 100, such as a cell phone 116 or PDA 110.

### Remote Programming of Wireless Device by Web Interface

In another preferred embodiment, the system and method of the present invention may be used to remotely adjust, activate, or reprogram features of the wireless device by utilizing a web interface or portal. In this preferred embodiment, the user may use a personal computer or other access device to log on to a dedicated web portal which is preconfigured with various user selectable commands which can be implemented in the wireless device. In this preferred embodiment, the user may type in the appropriate number corresponding to a preconfigured list of commands or select from a pull-down menu, or other means, to choose from a list of pre-defined commands to be sent to the wireless device. Upon receipt of this command, the server sends an SMS, GPRS or other type of wireless command to the device which can be interpreted to adjust, activate, or reprogram the designated device feature.

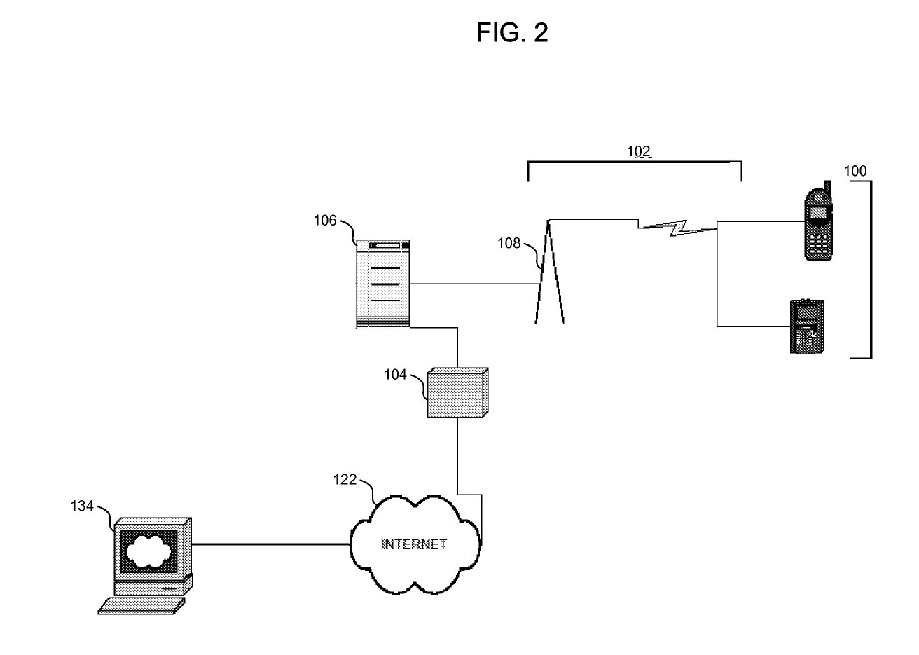

FIG. 2 is a simplified diagram illustrating the system components of another preferred embodiment of the present invention. As illustrated in FIG. 2, a wireless device 100 is capable of receiving instructions for programming the operational features of the device 100. The device 100 is connected via a wireless network 102 to a server 104. The server 104 is capable of receiving input from a user from a computer 134 via the Internet 122 or other computer network. The server 104 then transmits instructions for programming the feature in accordance with the user's input to the wireless device via a wireless connection 102.

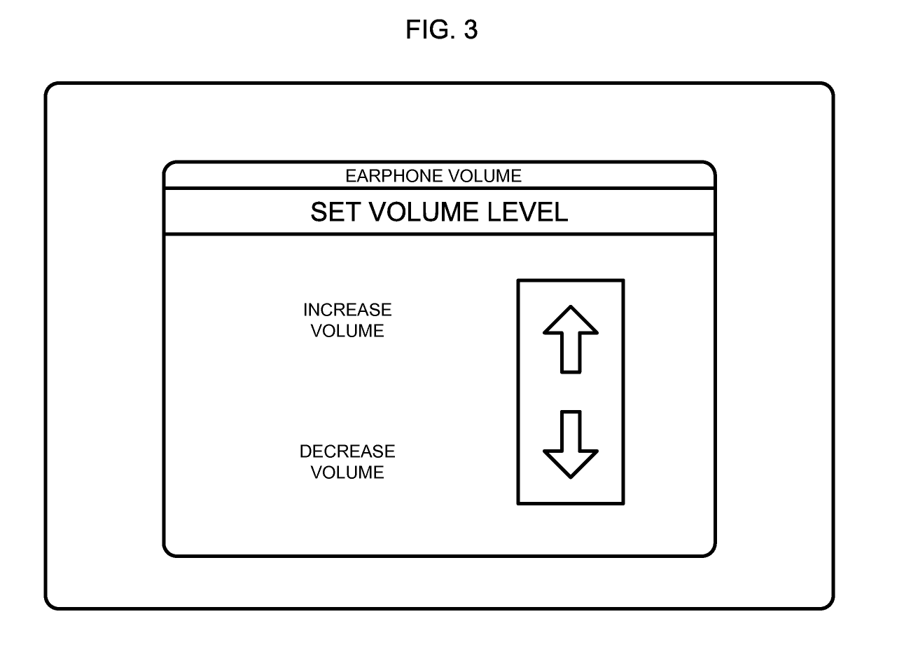

Referring to FIG. 3, a user interface application program menu can be provided on a suitable computer by the server to remotely adjust, activate, or reprogram features of the wireless device. The user may use a personal computer or other access device to log on to a dedicated web portal which is preconfigured with various user-selectable commands which can be transmitted to the wireless device. By using the user interface menu provided by the web server, the user may access information about one or more features of the wireless device. The menu for each device feature may include a description of the function and benefits of the feature, a tutorial on how to use the feature, and various options for activating, utilizing and/or adjusting the feature in the wireless device. As is well known in the field of web access technology, the user may select one of a plurality of designated IP addresses to access to initiate the session, each IP address associated with a unique one or group of wireless device features. For example, if the user desires to increase or decrease the earpiece listening volume, the user may utilize a specific IP address to access a user interface uniquely associated with controlling the listening volume of the wireless device.

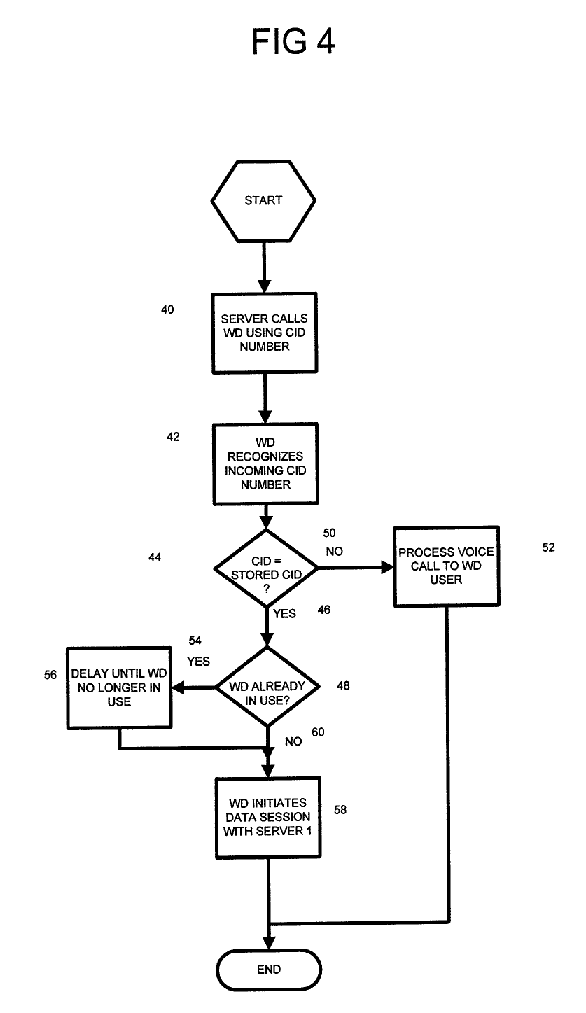

Referring to FIG. 4, a flow diagram further illustrates methodologies in accordance with a preferred embodiment of the present invention. First, in step 40, an initiating server 100 places a voice call out to the wireless device 122 using a predetermined CID number. The initiating server may be a software application deployed on a computer and it may or may not necessarily require a conventional telephone so long as there is access to the wireless network, directly or through the PSTN to the cellular network which in turn makes a wireless call to the wireless device. Next, in step 42, the wireless device recognizes the CID associated with the incoming voice call, and in step 44, upon identification of the CID number, a determination is made 44 as to whether the CID corresponds to any of the predetermined CIDs in the memory of the wireless device.

If the CID for the call matches the CID for an instruction in wireless device memory 46, the wireless device attempts to execute the corresponding instruction 48. For example, the receipt of a CID of XXX-XXX-XXXX might prompt the wireless device to decrease the earpiece listening volume by one unit. If the wireless device does not recognize the CID 50, it allows the call to be answered by the user in step 52. If the wireless device is already in use when the data prompt call is received 54, the wireless device waits until the current call is completed 56 and then initiates the data session 58.

Returning to FIG. 4, in executing the instruction in step 58 of FIG. 4, the wireless device establishes a short message service (SMS) or GPRS connection for the transmission and/or reception of data from the remote data server.

Additionally, the wireless device may also be programmed to recognize a particular CID number as a unique programming command for its internal software or data storage. In this case, the device does not need to initiate a data session to receive programming commands, as the CID corresponds to a unique programming command.

In another preferred embodiment of the present invention, the system may also include a “closed loop” feature which will notify the server that programming code has been received by the device and that the device has, in fact, been modified. If such confirmation is not received by the server within a predetermined time interval after the transmission of the feature programming instruction to the wireless device, the server may be programmed to retransmit the feature programming instruction to the wireless device and/or to provide appropriate notifications of the potential malfunction.

It will be obvious to those having skill in the art that many changes may be made to the details of the above-described embodiments without departing from the underlying principles of the invention. The scope of the present invention should, therefore, be determined only by the following claims.

It is to be understood that, while the detailed drawings and specific examples given describe preferred embodiments of the invention, they are for the purpose of illustration only, that the apparatus and method of the invention are not limited to the precise details and conditions disclosed and that various changes may be made therein without departing from the spirit of the invention which is defined by the following claims:

We claim:

1. A method for effecting data communications with a wireless communication device; the method comprising:
(a) configuring said wireless communication device for responding to at least one predetermined alert for initiating said data communications with at least one predetermined communicant;
(b) transmitting said at least one predetermined alert to said wireless communication device; and
(c) operating said wireless communication device in response to recognizing said at least one predetermined alert to initiate a data session for effecting said data communications with said at least one predetermined communicant.

2. The method for effecting data communications with a wireless communication device as recited in claim 1 wherein each respective predetermined alert of said at least one predetermined alert is identified with at least one respective communicant of said at least one predetermined communicant.

3. The method for effecting data communications with a wireless communication device as recited in claim 1 wherein said at least one predetermined alert is embodied in a caller identification code.

4. The method for effecting data communications with a wireless communication device as recited in claim 1 wherein said at least one predetermined alert is embodied in at least one of a short message service message, a packet data service message, a WIFI message, a Bluetooth message, a JAVA message or another wireless data session message.

5. The method for effecting data communications with a wireless communication device as recited in claim 1 wherein said wireless communication device further effects a response to said recognizing by carrying out a predetermined routine while participating in said data session.

6. The method for effecting data communications with a wireless communication device as recited in claim 2 wherein said at least one predetermined alert is embodied in a caller identification code.

7. The method for effecting data communications with a wireless communication device as recited in claim 2 wherein said at least one predetermined alert is embodied in at least one of a short message service message, a packet data service message, a WIFI message, a Bluetooth message, a JAVA message or another wireless data session message.

8. The method for effecting data communications with a wireless communication device as recited in claim 2 wherein said wireless communication device further effects a response to said recognizing by carrying out a predetermined routine while participating in said data session.

9. The method for effecting data communications with a wireless communication device as recited in claim 3 wherein said wireless communication device further effects a response to said recognizing by carrying out a predetermined routine while participating in said data session.

10. The method for effecting data communications with a wireless communication device as recited in claim 4 wherein said wireless communication device further effects a response to said recognizing by carrying out a predetermined routine while participating in said data session.

11. A system for effecting data communications with a wireless communication device by at least one communicant configured for wireless coupling with said wireless communication device; the system comprising:
(a) an alert responsive unit coupled with said wireless communication device; said alert responsive unit being configured for receiving at least one predetermined alert; and
(b) at least one alert transmitting device coupled with said at least one communicant; said at least one communicant employing said at least one alert transmitting device to effect transmitting at least one respective predetermined alert of said at least one predetermined alert to said wireless communication device;
said wireless communication device responding to recognizing said at least one respective predetermined alert to initiate a data session for effecting said data communications with said at least one communicant.

12. The system for effecting data communications with a wireless communication device by at least one communicant configured for wireless coupling with said wireless communication device as recited in claim 11 wherein each said respective predetermined alert is identified with at least one respective communicant of said at least one communicant.

13. The system for effecting data communications with a wireless communication device by at least one communicant configured for wireless coupling with said wireless communication device as recited in claim 11 wherein said at least one respective predetermined alert is embodied in a caller identification code.

14. The system for effecting data communications with a wireless communication device by at least one communicant configured for wireless coupling with said wireless communication device as recited in claim 11 wherein said at least one respective predetermined alert is embodied in at least one of a short message service message, a packet data service message, a WIFI message, a Bluetooth message, a JAVA message or another wireless data session message.

15. The system for effecting data communications with a wireless communication device by at least one communicant configured for wireless coupling with said wireless communication device as recited in claim 11 wherein said wireless communication device further effects a response to said recognizing by carrying out a predetermined routine while participating in said data session.

16. The system for effecting data communications with a wireless communication device by at least one communicant configured for wireless coupling with said wireless communication device as recited in claim 12 wherein said at least one respective predetermined alert is embodied in a caller identification code.

17. The system for effecting data communications with a wireless communication device by at least one communicant configured for wireless coupling with said wireless communication device as recited in claim 16 wherein said at least one respective predetermined alert is embodied in at least one of a short message service message, a packet data service message, a WIFI message, a Bluetooth message, a JAVA message or another wireless data session message.

18. The system for effecting data communications with a wireless communication device by at least one communicant configured for wireless coupling with said wireless communication device as recited in claim 17 wherein said wireless communication device further effects a response to said recognizing by carrying out a predetermined routine while participating in said data session.

19. A method for effecting data communications with a wireless communication device; the method comprising:
(a) configuring said wireless communication device for recognizing an alert message;
(b) transmitting said alert message to said wireless communication device from a
(c) operating said wireless communication device in response to recognizing said at alert message to cooperate with said communicant to initiate a data communication session with said communicant.

20. The method for effecting data communications with a wireless communication device as recited in claim 19 wherein said alert message identifies said communicant, and wherein said alert message is embodied in at least one of a caller identification code, a short message service message, a packet data service message, a WIFI message, a Bluetooth message, a JAVA message or another wireless data session message.
